(19) United States
(12) Patent Application Publication
(10) Pub. No.: US 2017/0015476 A1
(43) Pub. Date: Jan. 19, 2017

(54) REUSABLE CAP ASSEMBLY

(71) Applicant: Theresa McClellan, Clinton Township, MI (US)

(72) Inventor: Theresa McClellan, Clinton Township, MI (US)

(21) Appl. No.: 14/800,996

(22) Filed: Jul. 16, 2015

(51) Int. Cl. B65D 51/24; A61J 1/14; A61J 1/06

(52) U.S. Cl. CPC B65D 51/24; A61J 1/065; A61J 1/1412

(57) ABSTRACT

A cap assembly caps a sealed vial having a sealed flat top surface defining a top diameter and a side surface extending down therefrom. The cap assembly includes a cap top defining an outer surface and an inner surface. The cap top defines a cap diameter which is slightly larger than the top diameter. The cap top also defines a cap top periphery. A side rim extends out from the cap top about the cap top periphery to engage the side surface of the sealed vial. The side rim includes an inner surface. A pad is fixedly secured to the inner surface of the cap top. The pad is fabricated from an absorbent material, wherein the absorbent material is saturated with a liquid disinfectant 54 to disinfect the sealed top surface when the cap assembly covers the sealed vial in a manner such that the pad contacts the sealed flat top surface.

### BACKGROUND ART

1. Field of the Invention

The invention relates to caps that cover medicine vials. More particularly, the invention relates to a cap assembly that assists in maintaining the sanitation of the top of a medicine vial.

2. Description of the Related Art

As healthcare costs continue to increase, more and more individuals are self-administering medicines. This is especially true for diabetics that require regular insulin treatments, which are typically injected into the person. In several situations, a person that is injecting medicine does not use the entire volume of medicine in the vial. The person may store the vial with the remainder of the medicine therein for additional use at a later time. The problem with this is that the top of the vial is no longer sealed and may be exposed to unsanitary conditions. Health care facilities operate similarly such that unsealed vials are stored for future use so long as there is medicine still remaining in the vial.

### SUMMARY OF THE INVENTION

A cap assembly caps a sealed vial having a sealed flat top surface defining a top diameter and a side surface extending down therefrom. The cap assembly includes a cap top defining an outer surface and an inner surface. The cap top defines a cap diameter which is slightly larger than the top diameter. The cap top also defines a cap top periphery. A side rim extends out from the cap top about the cap top periphery to engage the side surface of the sealed vial. The side rim includes an inner surface. A pad is fixedly secured to the inner surface of the cap top. The pad is fabricated from an absorbent material, wherein the absorbent material is saturated with a liquid disinfectant 54 to disinfect the sealed top surface when the cap assembly covers the sealed vial in a manner such that the pad contacts the sealed flat top surface.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is an exploded perspective view of one embodiment of the invention with respect to a medicine vial;

FIG. 2 is a perspective view of the invention secured to the top of a medicine vial;

FIG. 3 is a partial cross-sectional side view of the invention secured to the top of a medicine vial, shown partially cut away; and

FIG. 4 is a perspective view of an alternative embodiment of the invention.

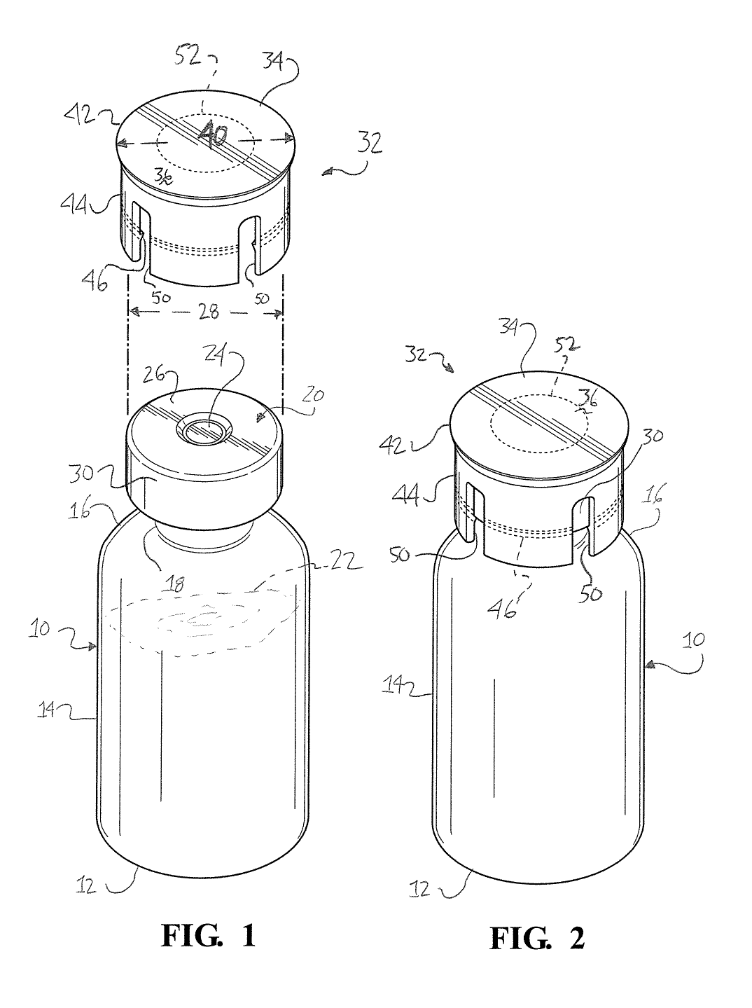

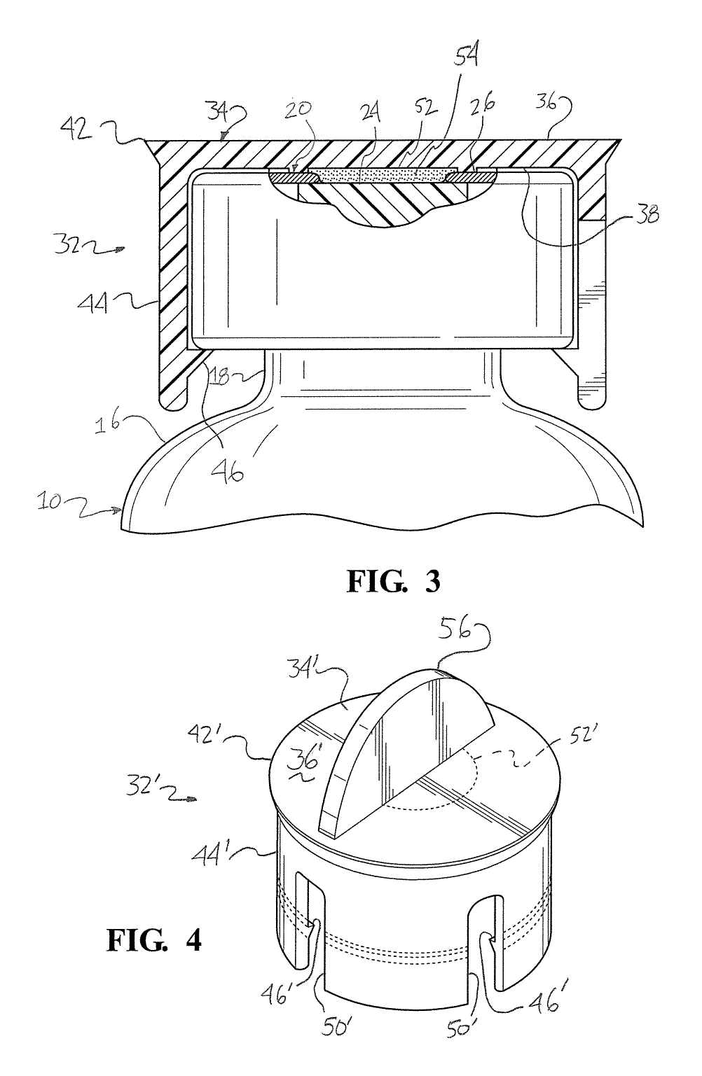

### DETAILED DESCRIPTION OF THE PREFERRED EMBODIMENT

Referring to the Figures, a medicine vial, generally shown at 10, includes a bottom surface 12, a side 14, a shoulder 16, a neck 18, and a sealed flat top surface 20. Medicine 22, shown in phantom, is stored within the medicine vial 10 for transport and subsequent use by a medical professional or person authorized to use the medicine 22. The medicine vial 10 is a sealed vial 10 wherein the sealed flat top surface 20 includes an injection center 24 and a hard flat surface 26 circumscribing the injection center 24. The injection center 24 is fabricated from a flexible material that is injectable by a needle adapted to be secured to a syringe (neither shown). The hard flat surface 26 defines a top diameter 28. A side surface 30 extends down from the hard flat surface 26 creating a cylinder. The cylinder created by the side surface 30 is generally wider in dimension than the diameter of the neck 18 of the medicine vial 10.

The invention, a reusable cap assembly, is generally indicated at 32. The reusable cap assembly 32 is reusable in the fact that it can be placed over the sealed flat top surface 20 of the medicine vial 10 after each use by the user in extracting medicine from the medicine vial 10.

The reusable cap assembly 32 includes a cap top 34 that defines an outer surface 36 and an inner surface 38. In the preferred embodiment, the outer 36 and inner 38 surfaces are parallel to each other. The cap top 34 defines a cap diameter 40 that is slightly larger than the top diameter 28 of the sealed flat top surface 20. Extending around the cap top 34 is a cap top periphery 42, which is in the shape of a circle. It should be appreciated by those skilled in the art that the cap top periphery 42 may include a tab or other such extension extending out from the cap top periphery 42 to change the shape of the cap top periphery 42 to something other than a circle to facilitate the ease of removal of the reusable cap assembly 32 from the medicine vial.

The cap top 34 also includes a side rim 44. The side rim 44 extends out from the cap top 34 at or about the cap top periphery 42. In the embodiments shown in the Figures, the cap top periphery 42 is larger than a periphery of the side rim 44. The side rim 44 defines a cylinder that is circular in cross section. The side rim 44 generally complements the side surface 30 of the sealed flat top surface 20. The side rim 44 includes a retainer 46 that positively engages the side surface of the sealed flat top surface 20 to inhibit the removal of the cap top 34 inadvertently from the medicine vial 10. In one embodiment, the retainer 46 is a ridge 46 that extends around an inner surface 48 of the side rim 44. The side rim 44 also includes a spring slot 50 that extends along a portion of the side rim 44 and allows the side rim 44 to pass over the side surface 30 of the sealed flat top surface 20 wherein the resiliency of the side rim 44 then springs back into position after the ridge 46 passes over the sealed flat top surface 20 to retain the cap top 34 on the medicine vial 10. In one embodiment, the side rim 44 will include a plurality of spring slots 50.

The cap assembly 34 includes a pad 52 that is fixedly secured to the inner surface 38 of the cap top 34. The pad 52 is fabricated from an absorbent material. In one embodiment, the absorbent material is rayon. Other embodiments, the pad 52 may be fabricated from polyester, a polymer gel, gelatin hydrogel pad, hydrofiber with ionic silver; silver ion wound pad dressing, polymer silver, silver antimicrobial alginate dressing, or cotton. The pad 52 may be saturated with a liquid disinfectant 54 to disinfect the sealed flat top surface 20 when the reusable cap assembly 32 covers the medicine vial 10 in a manner such that the pad 52 contacts the sealed flat top surface 20. The pad 52 may cover all of the inner surface 38 of the cap top 34 or, as shown in the Figures, a portion of the inner surface 38 complementing the injection center 24. A disinfectant 54 that is used may include pure alcohol, silver ion, polyvinyl alcohol, silver nitrate, acetic acid, and/or urethane.

In an alternative embodiment shown in cap FIG. 4, a handle 56 extends out from the outer surface 36 of the cap top 34. The handle 56 facilitates the removal of the reusable cap assembly 32 from the medicine vial 10. In the embodiment shown, the handle 56 is a semicircle.

The method of use includes obtaining a cap assembly 34 supplied in sterile packaging (not shown). Once a vial 10 is exposed for the retrieval of the medicine stored therein, the cap assembly 34 is removed from the sterile packaging, it is placed over the sealed flat top surface 20. When more medicine is needed, the cap assembly 34 is removed from the top surface 20 providing access thereto. Once more medicine is retrieved from the vial 10, the cap assembly 34 is resecured over the top surface 20. This can be repeated as long as there is medicine in the vial 10.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A cap assembly for capping a sealed vial having a sealed flat top surface defining a top diameter and a side surface extending down therefrom, said cap assembly comprising:
a cap top defining an outer surface and an inner surface, said cap top defining a cap diameter larger than the top diameter and a cap top periphery;
a side rim extending out from said cap top about said cap top periphery to engage the side surface of the sealed vial, said side rim including an inner surface;
a pad fixedly secured to said inner surface of said cap top, said pad being fabricated from an absorbent material, wherein said absorbent material is saturated with a liquid disinfectant to disinfect the sealed flat top surface when said cap assembly covers the sealed vial in a manner such that said pad contacts the sealed flat top surface.

2. A cap assembly as set forth in claim 1 including a handle extending out from said outer surface of said cap top.

3. A cap assembly as set forth in claim 1 wherein said side rim includes a retainer for positively engaging the side surface of the sealed vial.

4. A cap assembly as set forth in claim 3 wherein said retainer is a ridge extending around said inner surface parallel to said cap top.

5. A cap assembly as set forth in claim 4 wherein said side rim includes a spring slot extending along a portion of said side rim to allow said side rim and said ridge to pass over the side surface of the sealed vial.

6. A cap assembly as set forth in claim 5 wherein said spring slot extends perpendicular to said cap top.

7. A cap assembly as set forth in claim 4 wherein said side rim includes a plurality of spring slots extending along a portion of said side rim to allow said side rim and said ridge to pass over the side surface of the sealed vial.

8. A cap assembly as set forth in claim 1 wherein said pad covers all of said inner surface.

9. A cap assembly as set forth in claim 1 wherein said cap top includes a top edge extending out past said side rim.
